(19) United States
(12) Patent Application Publication
(10) Pub. No.: US 2021/0279768 A1
(43) Pub. Date: Sep. 9, 2021

(54) APPARATUSES AND METHODS FOR ENHANCING A PRESENTATION OF CONTENT WITH SURROUNDING SENSORS

(71) Applicant: AT&T Intellectual Property I, L.P., Atlanta, GA (US)

(72) Inventors: Tan Xu, Bridgewater, NJ (US); Bo Han, Bridgewater, NJ (US); Eric Zavesky, Austin, TX (US)

(73) Assignee: AT&T Intellectual Property I, L.P., Atlanta, GA (US)

(21) Appl. No.: 16/812,486

(22) Filed: Mar. 9, 2020

(51) Int. Cl. G06Q 30/02; G06T 19/00; H04W 4/02

(52) U.S. Cl. CPC G06Q 30/0267; G06Q 30/0261; H04W 4/027; G06T 19/006

(57) ABSTRACT

Aspects of the subject disclosure may include, for example, obtaining an identification of a device capability associated with a client device that is presenting a first scene that includes a first physical object and a first virtual object, determining a first location of the client device, responsive to the determining of the first location, obtaining an output from a sensor that is located within a threshold distance of the first location, processing the output from the sensor to identify a second virtual object in accordance with the identification of the device capability, and transmitting first data associated with the second virtual object to cause the client device to present the first physical object and the second virtual object in a second scene. Other embodiments are disclosed.

### FIELD OF THE DISCLOSURE

The subject disclosure relates to apparatuses and methods for enhancing a presentation of content with surrounding sensors.

### BACKGROUND

As the world becomes increasingly connected through vast communication networks and multiple types of communication devices, there are additional opportunities that are made available to present content to users. Users may utilize such communication devices to obtain insight/perspective regarding the environment around them. Extended reality or cross-reality (XR) technologies blend digital information and virtual objects with the real-world environment, thereby providing for data-enriched user experiences. However, data collection from sensors of XR devices is limited in terms of providing environmental information from a first-person perspective. Additionally, when XR technology is initialized it requires a wide scope/scan to understand location information, such as relative locations between objects. Furthermore, existing XR technology provides for limited types of inputs (e.g., gaze and hand gestures) that only capture partial user actions/behaviors for a user or other users/communication devices in proximity to the user.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for enhancing (a presentation of) one or more scenes with objects based on data or information obtained from one or more sensors. Other embodiments are described in the subject disclosure.

One or more aspects of the subject disclosure include, in whole or in part, identifying a first communication device, a first user of the first communication device, and a first sensor, obtaining, from the first communication device, a first output in accordance with the identifying of the first communication device, obtaining, from the first sensor, a second output in accordance with the identifying of the first sensor, obtaining a first preference associated with the first user in accordance with the identifying of the first user, obtaining a first configuration parameter associated with the first communication device in accordance with the identifying of the first communication device, obtaining a second configuration parameter associated with the first sensor in accordance with the identifying of the first sensor, generating a synthesized environment in accordance with the first preference and based on a processing of the first configuration parameter, the second configuration parameter, the first output, and the second output, wherein the synthesized environment includes a first object and a second object, and wherein the first object is a physical object and the second object is a virtual object, and providing the synthesized environment, a modified version of the synthesized environment, or a combination thereof, to the first communication device.

One or more aspects of the subject disclosure include, in whole or in part, presenting a first scene in accordance with a communication session, wherein the first scene includes a first physical object, transmitting first information corresponding to the first physical object, transmitting second information that identifies at least a first sensor, responsive to the transmitting of the first information and the transmitting of the second information, receiving third information that corresponds to a first virtual object, and responsive to the receiving of the third information, presenting a second scene subsequent to the presenting of the first scene, wherein the second scene includes the first physical object and the first virtual object.

One or more aspects of the subject disclosure include, in whole or in part, obtaining an identification of a device capability associated with a client device that is presenting a first scene that includes a first physical object and a first virtual object, determining a first location of the client device, responsive to the determining of the first location, obtaining an output from a sensor that is located within a threshold distance of the first location, processing the output from the sensor to identify a second virtual object in accordance with the identification of the device capability, and transmitting first data associated with the second virtual object to cause the client device to present the first physical object and the second virtual object in a second scene.

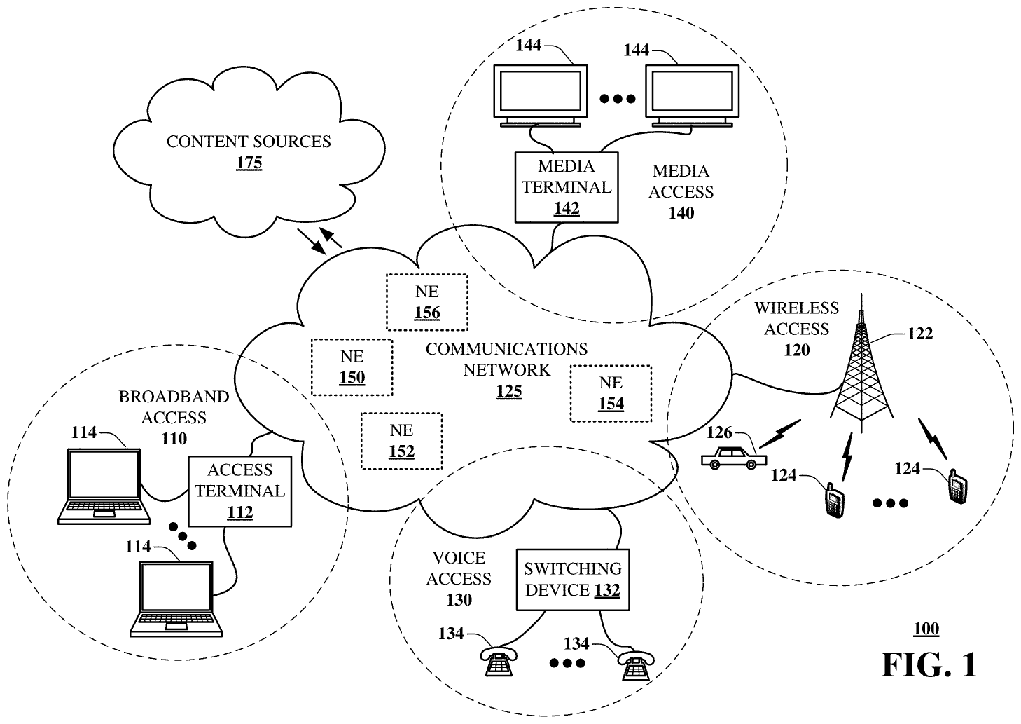

Referring now to FIG. 1, a block diagram is shown illustrating an example, non-limiting embodiment of a system 100 in accordance with various aspects described herein. For example, system 100 can facilitate in whole or in part identifying a first communication device, a first user of the first communication device, and a first sensor, obtaining, from the first communication device, a first output in accordance with the identifying of the first communication device, obtaining, from the first sensor, a second output in accordance with the identifying of the first sensor, obtaining a first preference associated with the first user in accordance with the identifying of the first user, obtaining a first configuration parameter associated with the first communication device in accordance with the identifying of the first communication device, obtaining a second configuration parameter associated with the first sensor in accordance with the identifying of the first sensor, generating a synthesized environment in accordance with the first preference and based on a processing of the first configuration parameter, the second configuration parameter, the first output, and the second output, wherein the synthesized environment includes a first object and a second object, and wherein the first object is a physical object and the second object is a virtual object, and providing the synthesized environment, a modified version of the synthesized environment, or a combination thereof, to the first communication device. System 100 can facilitate in whole or in part presenting a first scene in accordance with a communication session, wherein the first scene includes a first physical object, transmitting first information corresponding to the first physical object, transmitting second information that identifies at least a first sensor, responsive to the transmitting of the first information and the transmitting of the second information, receiving third information that corresponds to a first virtual object, and responsive to the receiving of the third information, presenting a second scene subsequent to the presenting of the first scene, wherein the second scene includes the first physical object and the first virtual object. System 100 can facilitate in whole or in part obtaining an identification of a device capability associated with a client device that is presenting a first scene that includes a first physical object and a first virtual object, determining a first location of the client device, responsive to the determining of the first location, obtaining an output from a sensor that is located within a threshold distance of the first location, processing the output from the sensor to identify a second virtual object in accordance with the identification of the device capability, and transmitting first data associated with the second virtual object to cause the client device to present the first physical object and the second virtual object in a second scene.

In particular, in FIG. 1 a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

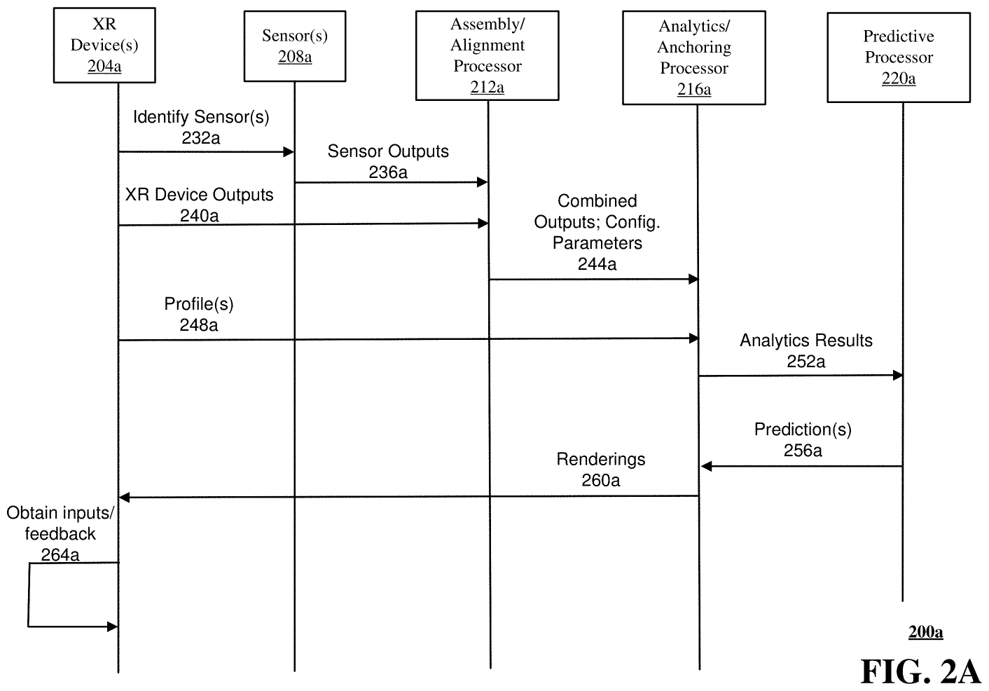

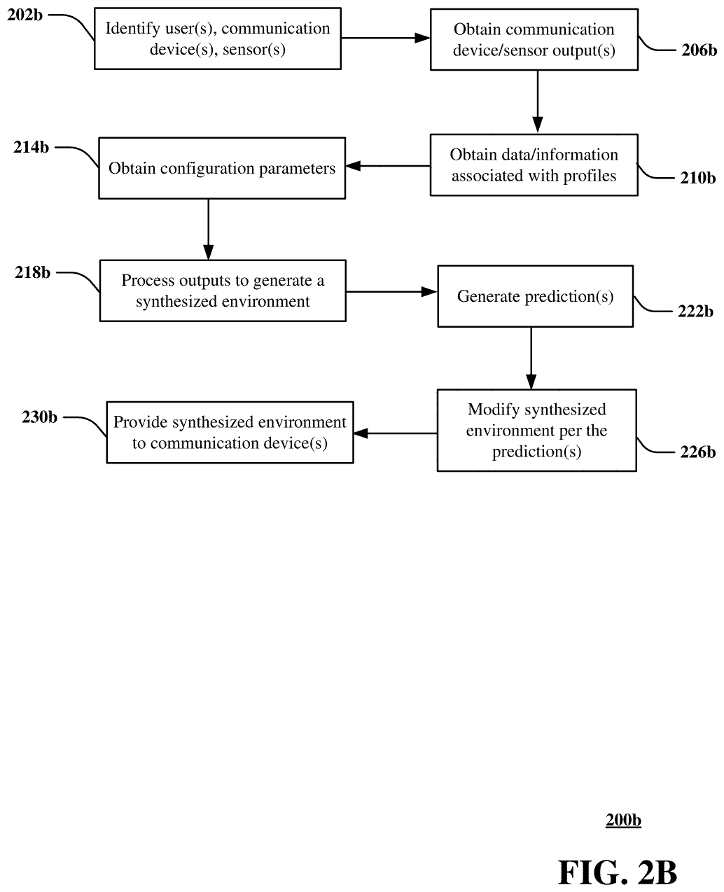

FIG. 2A is a block diagram illustrating an example, non-limiting embodiment of a system 200a functioning within, or operatively overlaid upon, the communication network 100 of FIG. 1 in accordance with various aspects described herein. Operations or methodological steps that may be performed or facilitated by the system 200a are described below.

The system 200a may include one or more XR devices 204a, one or more sensors 208a, an assembly/alignment processor 212a, an analytics/anchoring processor 216a, and a predictive processor 220a. The devices 204a-220a shown in FIG. 2A may be incorporated as part of a distributed processing system, whereby multiple processing systems may be communicatively coupled to one another, potentially via one or more networks. In some embodiments, two or more of the devices (e.g., the assembly/alignment processor 212a, the analytics/anchoring processor 216a, and/or the predictive processor 220a) may be included/incorporated within a common/same housing. In some embodiments, one or more operations or steps performed by a given device (as described below) may be performed, in part or in whole, by one or more other devices.

In some embodiments, one or more of the devices 204a-220a of the system 200a may support or include an interface that may facilitate interactions with one or more users. For example, an XR device 204a may include, e.g., a touchscreen, a stylus, a keypad, a keyboard, a microphone, a mouse, a trackball/trackwheel, etc., that may enable a user to enter one or more inputs. Similarly, the XR device 204a may include, e.g., a display screen, a speaker, etc., that may be used to render one or more outputs (e.g., one or more audiovisual outputs) that may be consumed by the user.

In step 232a, an XR device 204a may identify one or more of the sensors 208a. As part of the identification of step 232a, the XR device 204a (or a user thereof) may supply an indicator of a sensor 208a, such as for example a serial number of the sensor 208a (potentially in conjunction with a make and/or a model of the sensor 208a), an address of the sensor 208a, a pointer to the sensor 208a, a link to the sensor 208a, or the like. In some embodiments, the identification of step 232a may include the XR device 204a (or a user thereof) supplying a credential associated with the XR device 204a and/or the sensor 208a, and verifying the supplied credential to confirm that the XR device 204a (or a user thereof) is authorized to utilize/access the sensor 208a. In some embodiments, the credential may be based on a biometric parameter, such as for example a fingerprint or retinal scan, facial characteristics (e.g., facial recognition technology), etc.

The sensors 208a may include one or more cameras, such as for example one or more cameras that may be external to the XR device 204a. The sensors 208a may include other types or kinds of devices, such as for example a light detection and ranging (LIDAR) sensor, a temperature sensor, a wind sensor, a pressure sensor, a precipitation sensor (e.g., a rain or snow measurement sensor), a(n ambient) light sensor, a radio frequency (RF) sensor, a microphone, etc., or any combination thereof.

In step 236a, the sensors 208a may generate and provide outputs. For example, the outputs of the sensors 208a may be provided to the assembly/alignment processor 212a. One or more outputs from the XR devices 204a may be generated and provided to the assembly/alignment processor 212a in step 240a. The outputs of step 240a may include an identification of a location of an XR device 204a, information (e.g., audiovisual information, depth map) regarding a scene captured by the XR device 204a, etc.

The assembly/alignment processor 212a may combine or assemble the outputs obtained as part of steps 236a and 240a. For example, the combination of the outputs of steps 236a and 240a may serve to synthesize a presentation of a user's surroundings/environment in accordance with the various perspectives of the surroundings captured by the XR devices 204a and the sensors 208a. In this respect, the assembly/alignment processor 212a may join outputs from various (e.g., disparate) devices within a common framework to facilitate rendering a coherent presentation of such outputs as described further below. For example, the assembly/alignment processor 212a may align, or otherwise organize, objects captured by the XR devices 204a and/or the sensors 208a in terms of space (e.g., relative spatial locations) and/or time (in conjunction with step 244a described further below) so that the presentation is understandable to a user and is capable of being presented by the XR devices 204a given a capability of the XR devices 204a. As part of the alignment/organization, a reference or anchor point may be identified that may serve to relate a first output (e.g., a sensor output of step 236a) to one or more other outputs (e.g., a XR device output of step 240a).

In step 244a, the assembly/alignment processor 212a may provide the combination of the outputs (e.g., the synthesized environment) to the analytics/anchoring processor 216a. As part of step 244a, the assembly/alignment processor 212a may identify and provide configuration parameters to the analytics/anchoring processor 216a. The configuration parameters of step 244a may be associated with the XR devices 204a and/or the sensors 208a. For example, in the context of a camera, the configuration parameters may pertain to a resolution of the camera, a depth of the camera (e.g., a focal length of the camera, a geolocation of the camera, or a combination thereof), a perspective of the camera (potentially in conjunction with a specification of a field of view [FoV] of the camera), a bit rate associated with the camera, a refresh rate associated with the camera, etc. The configuration parameters of step 244a may be processed by the analytics/anchoring processor 216a to refine the synthesized model of the combined outputs provided by the assembly/alignment processor 212a.

In step 248a, the XR devices 204a (and/or any other device) may provide information or data pertaining to one or more profiles to the analytics/anchoring processor 216a. The profiles of step 248a may include a specification of a capability of a device, such as for example a display capability, an audio capability, or the like. The profiles of step 248a may include a specification of one or more user preferences, such as for example user responses to queries for information or prompts. The profiles of step 248a may include a log/record of content (e.g., media) consumed by the XR devices 204a or users thereof, communication sessions engaged in by the XR devices 204a or users thereof, etc.

In step 252a, the analytics/anchoring processor 216a may process the combined outputs and configuration parameters of step 244a, and the profile(s) of step 248a, to generate analytical/analytics results that may be provided to the predictive processor 220a. The analytics results of step 252a may include information about a user and/or an object, including for example object detection/position/tracking information, semantic information of user activities (e.g., moving, exploring, focusing on something such as an object), information regarding interactions between objects, and information related to adjacent/proximate users. The analytics results of step 252a may include information pertaining to light maps, detected planes, surface/texture characteristics (e.g., simplifications, which may be facilitated by one or more outputs of a cloud computing device and/or a mobile edge computing device).

In step 256a, and based on the analytics results of step 252a, the predictive processor 220a may generate one or more predictions. The predictions of step 256a may be provided to the analytics/anchoring processor 216a. The predictions of step 256a may include information or a specification regarding a predicted trajectory of a user or device (e.g., an XR device 204a), which may be particularly prevalent in connection with mobile computing applications. For example, the predictions may be based on an analysis of a current direction (e.g., a current viewing direction), speed, gait/step-size of a user or device, etc. The predictions of step 256a may include information or a specification pertaining to likely viewing perspectives of a user or device (e.g., an XR device 204a). Aspects of the predictions of step 256a may identify objects (e.g., obstacles or obstructions in a line-of-sight or line-of-path) that may be present in a future FoV. To the extent that a given object represents a potential hazard, surface ornamentation (e.g., highlighting or other emphasis) may be applied to the object as part of the prediction in step 256a. More generally, one or more objects may be emphasized (or, analogously, de-emphasized) as part of step 256a.

The analytics/anchoring processor 216a may process the predictions of step 256a to generate one or more renderings in step 260a; the analytics/anchoring processor 216a may provide the renderings to the XR devices 204a as part of step 260a. As part of the processing of step 260a, the analytics/anchoring processor 216a may be able to simplify/reduce the amount of data that is transmitted to the XR devices 204a to facilitate a rendering/presentation of a synthesized XR environment. For example, the prediction(s) of step 256a may be analyzed as part of step 260a to include a subset (e.g., less than all) of the potential data that may be associated with a synthesized XR environment. Thus, communication bandwidth and processing resources (of, e.g., the XR devices 204a) may be preserved by only transmitting data that is likely to be consumed/accessed/utilized by a user in an amount greater than a threshold.

In some embodiments, as part of step 260a, high-quality data (e.g., data with an associated quality/resolution that is greater than a threshold) associated with a prediction (e.g., a predicted viewing direction) may be provided, and lower-quality data (e.g., data with an associated quality/resolution that is less than a threshold) may be provided where it is unlikely that a user will consume/access/utilize the data in accordance with the prediction (e.g., the predicted viewing direction). In this respect, and as a result of providing the lower-quality data, even if a prediction ends up being incorrect, there will still be sufficient data provisioned to the XR device 204a to facilitate a presentation/rendering as part of step 260a.

As part of step 260a, an XR device 204a may render/present a synthesized XR environment, that may include one or more physical objects and/or one or more virtual objects. In some embodiments, an XR device 204a may save/stored the synthesized XR environment as part of step 260a for future playback.

In step 264a, user-generated inputs and/or feedback may be obtained and analyzed by, e.g., the XR devices 204a, in order to update/modify the profile(s) (see, e.g., step 248a: profiles). In this respect, as additional information/data regarding a user and/or a device is obtained, the system 200a (e.g., the predictive processor 220a) may generate more accurate predictions, thereby reducing any potential error in future predictions and incentivizing further user adoption. Thus, aspects of the system 200a my incorporate machine learning (ML) and/or artificial intelligence (AI) based technologies to identify opportunities for enhancing one or more presentations/renderings.

Turning now to FIG. 2B, an illustrative embodiment of a method 200b in accordance with various aspects described herein is depicted. The method 200b may be at least partially executed in conjunction with one or more systems, devices, and/or components, such as for example one or more of the systems, devices, and/or components described herein. In some embodiments, one or more blocks/operations (or a portion thereof) of the method 200b may be combined/implemented with one or more of the steps (or portions thereof) described above in connection with the system 200a of FIG. 2A.

In block 202b, one or more users, communication devices (e.g., XR devices), and/or sensors may be identified. The identification of block 202b may be based on a user logging-in or subscribing to a service. The identification of block 202b may be based on a user initiating a communication session. The identification of block 202b may be based on a communication device coming within a communication range of another device (e.g., another communication device and/or sensor).

In block 206b, outputs of the communication devices and/or sensors identified in block 202b may be obtained. For example, the outputs may be obtained in block 206b in accordance with a push model, whereby the communication devices and/or sensors provide the outputs as soon as the outputs are available. In some embodiments, the outputs may be obtained in block 206b in accordance with a pull model, whereby the communication devices and/or sensors provide the outputs upon request. The output(s) of block 206b may pertain/relate to an environment where one or more users is located/positioned.

In block 210b, data/information associated with one or more profiles may be obtained. The data/information that is obtained may be based on a log/record of actions taken by one or more users, interactions between users, objects, or combinations thereof, an identification of media consumed by one or more users and/or presented by one or more communication devices, calendar information regarding planned future events or conditions, user or device preferences (as expressly entered/provided or as inferred), etc.

In block 214b, configuration parameters associated with the communication devices and/or the sensors (identified in block 202b) may be obtained. The configuration parameters may be saved/stored as part of block 214b to facilitate future executions of the method 200b without a need to re-obtain the configuration parameters.

In block 218b, the outputs (of block 206b) may be processed (e.g., combined) to generate a synthesized environment. The synthesized environment may correspond to an XR environment, incorporating aspects of users, devices, objects, events, and conditions, in terms of one or more physical (e.g., real-world) and/or virtual representations. The processing of block 218b may be based on the profiles (of block 210b) and the configuration parameters (of block 214b).

In block 222b, one or more predictions may be generated. The prediction(s) of block 222b may pertain to one or more users, devices, objects, events, conditions, or any combination thereof.

In block 226b, the synthesized environment may be processed (e.g., modified/updated) in accordance with the predictions to generate a modified synthesized environment. The modified synthesized environment of block 226b may include an enhancement applied to at least a first part/portion of the synthesized environment of block 218b. The modified synthesized environment of block 226b may include a de-emphasis applied to, or even a complete elimination of, a second part/portion of the synthesized environment of block 218b.

In block 230b, the synthesized environment (of block 218b, as potentially modified per blocks 222b and 226b described above) may be provided (e.g., transmitted) to one or more of the communication devices. As part of block 230b, the one or more communication devices may present/render the synthesized environment and/or may save/store the synthesized environment to facilitate a future playback/presentation.

While for purposes of simplicity of explanation, the respective processes are shown and described as a series of blocks in FIG. 2B, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

Aspects of the disclosure include a connectivity between XR devices and surrounding sensors (e.g., surrounding cameras), potentially in conjunction with third-party equipment, devices and/or capabilities, to generate a more comprehensive and wider characterization/modeling of a surrounding environment. As a result, a user of a system or device of this disclosure may obtain a greater understanding/perception regarding the surrounding environment, thereby enhancing the user's decision-making abilities and interactions concerning the surrounding environment.

Aspects of this disclosure may update parameters in real-time (or substantially in real-time) in order to provide a user with real-time, accurate information/data regarding a surrounding environment. In some embodiments, information/data that is critical to a given task may be prioritized (potentially as part of a real-time processing thread or application) relative to information/data that is less critical to the given task. In this respect, less important information/data may be relegated to background processing resources.

As described herein, aspects of the disclosure may combine outputs from one or more XR devices and/or one or more sensors to generate a synthesized environment that may be presented/rendering by a given XR device. The use of multiple devices and/or sensors may enable/provide for longer historical observations (e.g., observations with a continuous view of a scene, as opposed to one that is first-person in nature), potentially in conjunction with interactions (e.g., historical interactions) between users, devices, and/or objects.

Aspects of the disclosure may combine various outputs or conditions without imposing excessive burdens on users or communication devices. Such combinations may occur/execute as part of a background task, to avoid detracting from a user experience.

As described herein, aspects of the disclosure may enhance the efficiency of resources by reducing a space (e.g., a search space) for anchor initialization in XR devices. As a result, a reduction in bandwidth and computational/processing resources may be obtained without sacrificing: (1) precision in terms of, e.g., XR object anchoring, or (2) quality in terms of presentations/renderings.

Aspects of this disclosure may be implemented in conjunction with one or more applications. For example, aspects of the disclosure may facilitate vehicle operations (including autonomous vehicles), gaming (e.g., video gaming, multi-player online games, etc.), medical procedures (e.g., surgeries), industrial applications (e.g., mining, construction, factory activities), etc.

Aspects of the disclosure may combine information/data obtained or derived from multiple sources, such as for example from one or more publicly operated or accessible cameras, to facilitate multi-user XR experiences. Insights may be obtained from users and/or autonomous actors (e.g., robots, drones, etc.) to enhance the XR experiences. The XR experiences may be managed or controlled, potentially in accordance with an identity of a user and/or a communication device. For example, aspects of the disclosure may arbitrate conflicts between users and/or communication devices in respect of, e.g., an object included in an XR environment.

Aspects of the disclosure may entail/include a first system providing location and trajectory information to other systems/platforms (e.g., network planning systems, civil service/utility systems, etc.). The other systems/platforms may be operative on such information to understand the flow and actions (e.g., interactions) of users and/or objects as the users and/or objects navigate a particular space. Based on such an understanding, resources may be allocated by the systems/platforms accordingly.

In some embodiments, controls may be applied to address security and/or privacy considerations. For example, a first control may dictate whether information pertaining to a first user can be shared with one or more other users. In some embodiments, activities undertaken by a user in respect of media, such as for example social media, may be analyzed/examined to determine whether information sharing is appropriate. Permissions-based capabilities may be included to enable a user to opt-in (or, analogously, opt-out) to sharing information or data.

Aspects of this disclosure may control/manage a hand-over of operations from a first device to one or more additional devices (and, analogously, from the one or more additional devices to the first device). Such a hand-over may occur seamlessly based on a sharing of contextual/configuration data between the devices, thereby avoiding detracting from the user experience.

In some embodiments, characteristics/parameters associated with an environment, objects, and/or users may be combined to generate a synthesized model or representation of the environment. Simulations may aid a determination/identification of such characteristics.

As described herein, aspects of the disclosure may be implemented utilizing a distributed computing/processing architecture. In some embodiments, block-chain technologies (e.g., a public-facing ledger) may be utilized such that predictions and observations are logged with time and position/location stamps. The time and position/location stamps may serve as an authentication mechanism to validate/verify a given transaction or event.

Aspects of the disclosure may be used to present one or more portions of content items, such as media content items, advertisements, etc. In some embodiments, one or more presentations may include one or more scenes that may be presented by a device (e.g., a client device). The scenes may include one or more physical objects and/or one or more virtual objects. In some embodiments, a virtual object may include a content item, such as an advertisement. One or more presentations may occur in conjunction with (an identification of) one or more communication sessions, communication devices, and/or sensors.

Aspects of the disclosure may tailor/customize a viewing perspective, a resolution/quality, etc., associated with an object (potentially in one or more scenes). For example, such customization/tailoring may be based at least in part on information or parameters that may be associated with one or more communication devices, sensors, communication sessions, etc.

As described herein, data or information associated with synthesized environments may be transmitted by one or more devices and received by one or more devices. Variations of a given synthesized environment may also be transmitted and/or received by one or more devices. For example, such variations may be included as part of one or more versions of the given synthesized environment.

Aspects of the disclosure may utilize data or information obtained from one or more sensors. The data or information may be generated as one or more outputs of the sensor(s). The sensor(s) may be identified or determined on the basis of the sensor(s) being located within a threshold distance of one or more communication devices. The threshold distance may be based on a communication range of the communication device(s) and/or the sensor(s).

In some embodiments, data or information obtained from one or more sensors may be used to augment/supplement data or information obtained from a given device (e.g., an XR device). In an exemplary embodiment, the given device may only capture data/information associated with a portion of a user. The data or information obtained from the sensor(s) may correspond to a remainder of the user. Similarly, the given device may only capture data/information associated with a portion of an environment surrounding a user (e.g., surrounding the user within a threshold distance of the user); the data/information obtained from the sensor(s) may correspond to a remainder of the environment surrounding the user.

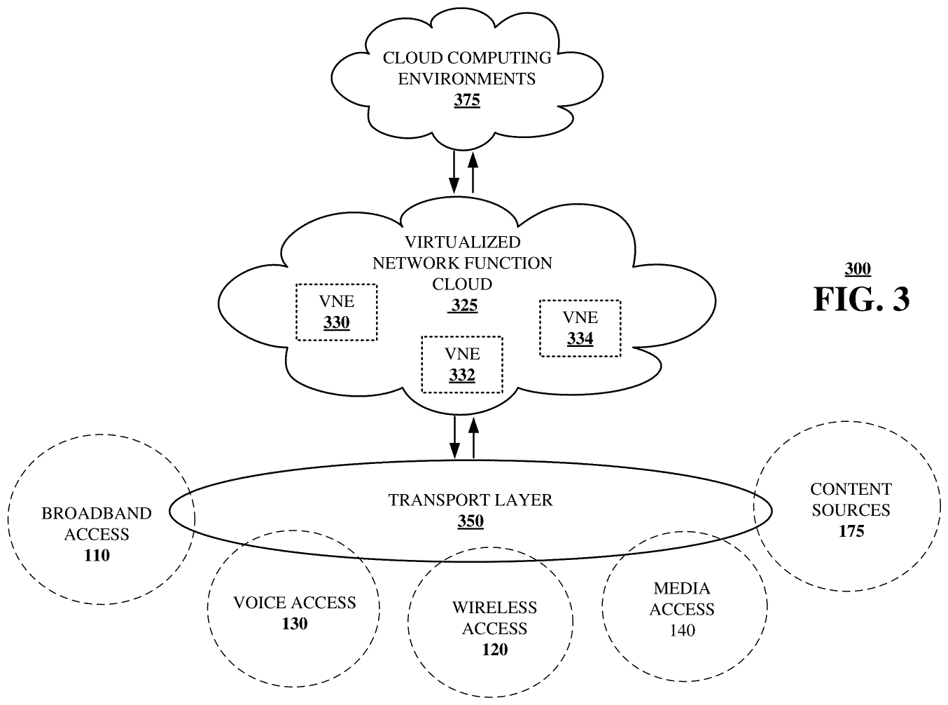

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of system 200a, and method 200b presented in FIGS. 1, 2A, and 2B. For example, virtualized communication network 300 can facilitate in whole or in part identifying a first communication device, a first user of the first communication device, and a first sensor, obtaining, from the first communication device, a first output in accordance with the identifying of the first communication device, obtaining, from the first sensor, a second output in accordance with the identifying of the first sensor, obtaining a first preference associated with the first user in accordance with the identifying of the first user, obtaining a first configuration parameter associated with the first communication device in accordance with the identifying of the first communication device, obtaining a second configuration parameter associated with the first sensor in accordance with the identifying of the first sensor, generating a synthesized environment in accordance with the first preference and based on a processing of the first configuration parameter, the second configuration parameter, the first output, and the second output, wherein the synthesized environment includes a first object and a second object, and wherein the first object is a physical object and the second object is a virtual object, and providing the synthesized environment, a modified version of the synthesized environment, or a combination thereof, to the first communication device. Virtualized communication network 300 can facilitate in whole or in part presenting a first scene in accordance with a communication session, wherein the first scene includes a first physical object, transmitting first information corresponding to the first physical object, transmitting second information that identifies at least a first sensor, responsive to the transmitting of the first information and the transmitting of the second information, receiving third information that corresponds to a first virtual object, and responsive to the receiving of the third information, presenting a second scene subsequent to the presenting of the first scene, wherein the second scene includes the first physical object and the first virtual object. Virtualized communication network 300 can facilitate in whole or in part obtaining an identification of a device capability associated with a client device that is presenting a first scene that includes a first physical object and a first virtual object, determining a first location of the client device, responsive to the determining of the first location, obtaining an output from a sensor that is located within a threshold distance of the first location, processing the output from the sensor to identify a second virtual object in accordance with the identification of the device capability, and transmitting first data associated with the second virtual object to cause the client device to present the first physical object and the second virtual object in a second scene.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general purpose processors or general purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it's elastic: so the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements don't typically need to forward large amounts of traffic, their workload can be distributed across a number of servers—each of which adds a portion of the capability, and overall which creates an elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

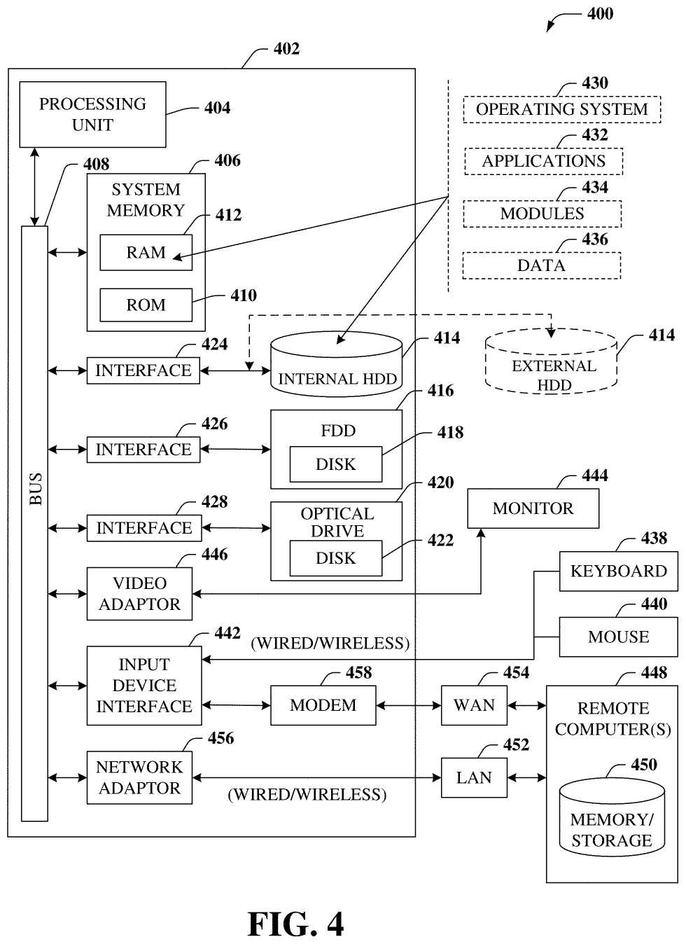

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part identifying a first communication device, a first user of the first communication device, and a first sensor, obtaining, from the first communication device, a first output in accordance with the identifying of the first communication device, obtaining, from the first sensor, a second output in accordance with the identifying of the first sensor, obtaining a first preference associated with the first user in accordance with the identifying of the first user, obtaining a first configuration parameter associated with the first communication device in accordance with the identifying of the first communication device, obtaining a second configuration parameter associated with the first sensor in accordance with the identifying of the first sensor, generating a synthesized environment in accordance with the first preference and based on a processing of the first configuration parameter, the second configuration parameter, the first output, and the second output, wherein the synthesized environment includes a first object and a second object, and wherein the first object is a physical object and the second object is a virtual object, and providing the synthesized environment, a modified version of the synthesized environment, or a combination thereof, to the first communication device. Computing environment 400 can facilitate in whole or in part presenting a first scene in accordance with a communication session, wherein the first scene includes a first physical object, transmitting first information corresponding to the first physical object, transmitting second information that identifies at least a first sensor, responsive to the transmitting of the first information and the transmitting of the second information, receiving third information that corresponds to a first virtual object, and responsive to the receiving of the third information, presenting a second scene subsequent to the presenting of the first scene, wherein the second scene includes the first physical object and the first virtual object. Computing environment 400 can facilitate in whole or in part obtaining an identification of a device capability associated with a client device that is presenting a first scene that includes a first physical object and a first virtual object, determining a first location of the client device, responsive to the determining of the first location, obtaining an output from a sensor that is located within a threshold distance of the first location, processing the output from the sensor to identify a second virtual object in accordance with the identification of the device capability, and transmitting first data associated with the second virtual object to cause the client device to present the first physical object and the second virtual object in a second scene.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

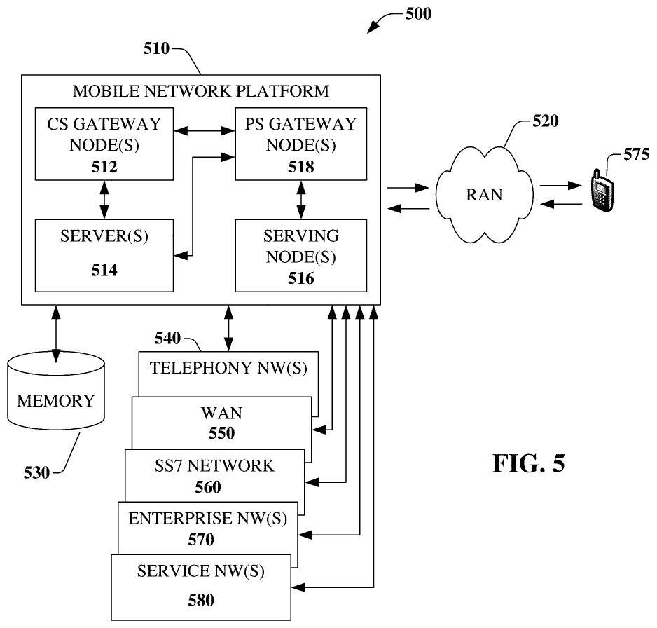

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part identifying a first communication device, a first user of the first communication device, and a first sensor, obtaining, from the first communication device, a first output in accordance with the identifying of the first communication device, obtaining, from the first sensor, a second output in accordance with the identifying of the first sensor, obtaining a first preference associated with the first user in accordance with the identifying of the first user, obtaining a first configuration parameter associated with the first communication device in accordance with the identifying of the first communication device, obtaining a second configuration parameter associated with the first sensor in accordance with the identifying of the first sensor, generating a synthesized environment in accordance with the first preference and based on a processing of the first configuration parameter, the second configuration parameter, the first output, and the second output, wherein the synthesized environment includes a first object and a second object, and wherein the first object is a physical object and the second object is a virtual object, and providing the synthesized environment, a modified version of the synthesized environment, or a combination thereof, to the first communication device. Platform 510 can facilitate in whole or in part presenting a first scene in accordance with a communication session, wherein the first scene includes a first physical object, transmitting first information corresponding to the first physical object, transmitting second information that identifies at least a first sensor, responsive to the transmitting of the first information and the transmitting of the second information, receiving third information that corresponds to a first virtual object, and responsive to the receiving of the third information, presenting a second scene subsequent to the presenting of the first scene, wherein the second scene includes the first physical object and the first virtual object. Platform 510 can facilitate in whole or in part obtaining an identification of a device capability associated with a client device that is presenting a first scene that includes a first physical object and a first virtual object, determining a first location of the client device, responsive to the determining of the first location, obtaining an output from a sensor that is located within a threshold distance of the first location, processing the output from the sensor to identify a second virtual object in accordance with the identification of the device capability, and transmitting first data associated with the second virtual object to cause the client device to present the first physical object and the second virtual object in a second scene.

In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processor can execute code instructions stored in memory 530, for example. It is should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

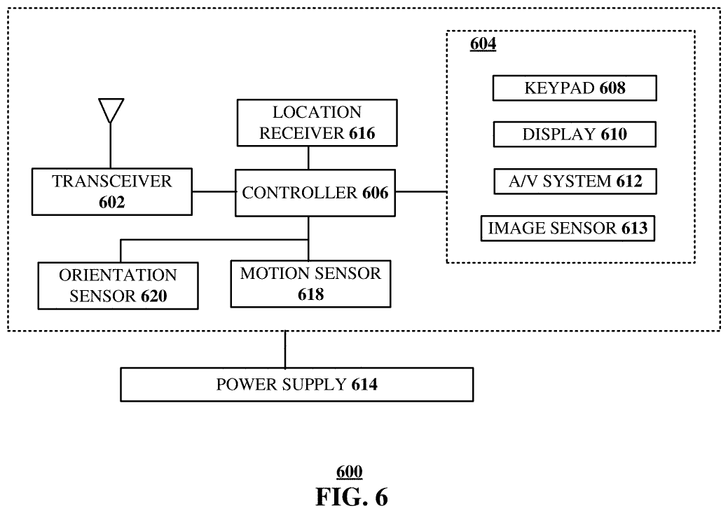

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part identifying a first communication device, a first user of the first communication device, and a first sensor, obtaining, from the first communication device, a first output in accordance with the identifying of the first communication device, obtaining, from the first sensor, a second output in accordance with the identifying of the first sensor, obtaining a first preference associated with the first user in accordance with the identifying of the first user, obtaining a first configuration parameter associated with the first communication device in accordance with the identifying of the first communication device, obtaining a second configuration parameter associated with the first sensor in accordance with the identifying of the first sensor, generating a synthesized environment in accordance with the first preference and based on a processing of the first configuration parameter, the second configuration parameter, the first output, and the second output, wherein the synthesized environment includes a first object and a second object, and wherein the first object is a physical object and the second object is a virtual object, and providing the synthesized environment, a modified version of the synthesized environment, or a combination thereof, to the first communication device. Computing device 600 can facilitate in whole or in part presenting a first scene in accordance with a communication session, wherein the first scene includes a first physical object, transmitting first information corresponding to the first physical object, transmitting second information that identifies at least a first sensor, responsive to the transmitting of the first information and the transmitting of the second information, receiving third information that corresponds to a first virtual object, and responsive to the receiving of the third information, presenting a second scene subsequent to the presenting of the first scene, wherein the second scene includes the first physical object and the first virtual object. Computing device 600 can facilitate in whole or in part obtaining an identification of a device capability associated with a client device that is presenting a first scene that includes a first physical object and a first virtual object, determining a first location of the client device, responsive to the determining of the first location, obtaining an output from a sensor that is located within a threshold distance of the first location, processing the output from the sensor to identify a second virtual object in accordance with the identification of the device capability, and transmitting first data associated with the second virtual object to cause the client device to present the first physical object and the second virtual object in a second scene.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

1. A device, comprising:
a processing system including a processor; and
a memory that stores executable instructions that, when executed by the processing system, facilitate performance of operations, the operations comprising:
identifying a first communication device and a first sensor;
obtaining, from the first communication device, a first output in accordance with the identifying of the first communication device;
obtaining, from the first sensor, a second output in accordance with the identifying of the first sensor;
generating a synthesized environment based on a processing of the first output and the second output, wherein the synthesized environment includes a first object and a second object, and wherein the first object is a physical object and the second object is a virtual object; and
providing the synthesized environment, a modified version of the synthesized environment, or a combination thereof, to the first communication device.

2. The device of claim 1, wherein the operations further comprise:
identifying a user of the first communication device; and
generating a prediction regarding the first communication device, the user, the first sensor, an event, a condition, or any combination thereof.

3. The device of claim 2, wherein the operations further comprise:
modifying the synthesized environment in accordance with the prediction, resulting in the modified version of the synthesized environment,
wherein the providing of the synthesized environment, the modified version of the synthesized environment, or the combination thereof, to the first communication device comprises providing the modified version of the synthesized environment.

4. The device of claim 2, wherein the prediction is based on a current viewing direction associated with the first communication device, a speed of the user, a gait of the user, a step-size of the user, or any combination thereof.

5. The device of claim 2, wherein the prediction is based on a first location of the first communication device at a first point in time and information in a calendar of the user indicating a second location of the user at a second point in time that is subsequent to the first point in time.

6. The device of claim 1, wherein the operations further comprise:
identifying a user of the first communication device;
obtaining a first preference associated with the user in accordance with the identifying of the user;
obtaining a first configuration parameter associated with the first communication device in accordance with the identifying of the first communication device; and
obtaining a second configuration parameter associated with the first sensor in accordance with the identifying of the first sensor,
wherein the generating of the synthesized environment is further based on a processing of the first configuration parameter and the second configuration parameter in accordance with the first preference.

7. The device of claim 1, wherein the operations further comprise:
identifying a second communication device and a user of the second communication device;
obtaining, from the second communication device, a third output in accordance with the identifying of the second communication device;
obtaining a preference associated with the user in accordance with the identifying of the user; and
obtaining a configuration parameter associated with the second communication device in accordance with the identifying of the second communication device,
wherein the generating of the synthesized environment is further based on a processing of the third output and the configuration parameter in accordance with the preference.

8. The device of claim 7, wherein the operations further comprise:
providing the synthesized environment, the modified version of the synthesized environment, or the combination thereof, to the second communication device.

9. The device of claim 1, wherein the operations further comprise:
identifying a second sensor; and
obtaining a configuration parameter associated with the second sensor in accordance with the identifying of the second sensor,
wherein the generating of the synthesized environment is further based on a processing of the configuration parameter.

10. The device of claim 1, wherein the first sensor includes a camera.

11. The device of claim 10, wherein the operations further comprise:
obtaining a configuration parameter associated with the camera,
wherein the configuration parameter comprises a resolution of the camera, a depth of the camera, a perspective of the camera, a bit rate associated with the camera, a refresh rate associated with the camera, or any combination thereof, and
wherein the generating of the synthesized environment is further based on a processing of the configuration parameter.

12. The device of claim 1, wherein the operations further comprise:
obtaining a configuration parameter associated with the first communication device,
wherein the configuration parameter is associated with a communication session between the first communication device and a second communication device, and
wherein the generating of the synthesized environment is further based on a processing of the configuration parameter.

13. The device of claim 1, wherein the operations further comprise:
obtaining a configuration parameter associated with the first communication device,
wherein the configuration parameter identifies a display capability of the first communication device, an audio capability of the first communication device, or a combination thereof, and
wherein the generating of the synthesized environment is further based on a processing of the configuration parameter.

14-20. (canceled)

21. A non-transitory, machine-readable medium, comprising executable instructions that, when executed by a processing system including a processor, facilitate performance of operations, the operations comprising:
identifying a first communication device and a first sensor;
obtaining, from the first communication device, a first output in accordance with the identifying of the first communication device;
obtaining, from the first sensor, a second output in accordance with the identifying of the first sensor;
generating a synthesized environment based on a processing of the first output and the second output, wherein the synthesized environment includes a first object and a second object, and wherein the first object is a physical object and the second object is a virtual object; and
providing the synthesized environment, a modified version of the synthesized environment, or a combination thereof, to the first communication device.

22. The non-transitory, machine readable medium of claim 21, wherein the operations further comprise:
identifying a user of the first communication device;
obtaining a first preference associated with the user in accordance with the identifying of the user;
obtaining a first configuration parameter associated with the first communication device in accordance with the identifying of the first communication device; and
obtaining a second configuration parameter associated with the first sensor in accordance with the identifying of the first sensor,
wherein the generating of the synthesized environment is further based on a processing of the first configuration parameter and the second configuration parameter in accordance with the first preference.

23. The non-transitory, machine readable medium of claim 21, wherein the operations further comprise:
identifying a second communication device and a user of the second communication device;
obtaining, from the second communication device, a third output in accordance with the identifying of the second communication device;
obtaining a preference associated with the user in accordance with the identifying of the user; and
obtaining a configuration parameter associated with the second communication device in accordance with the identifying of the second communication device,
wherein the generating of the synthesized environment is further based on a processing of the third output and the configuration parameter in accordance with the preference.

24. The non-transitory, machine readable medium of claim 23, wherein the operations further comprise:
providing the synthesized environment, the modified version of the synthesized environment, or the combination thereof, to the second communication device.

25. A method comprising:
identifying a first communication device and a first sensor;
obtaining, by a processing system including a processor and from the first communication device, a first output in accordance with the identifying of the first communication device;
obtaining, by the processing system and from the first sensor, a second output in accordance with the identifying of the first sensor;
generating, by the processing system, a synthesized environment based on a processing of the first output and the second output, wherein the synthesized environment includes a first object and a second object, and wherein the first object is a physical object and the second object is a virtual object; and
providing, by the processing system, the synthesized environment, a modified version of the synthesized environment, or a combination thereof, to the first communication device.

26. The method of claim 25, further comprising:
identifying, by the processing system, a user of the first communication device; and
generating, by the processing system, a prediction regarding the first communication device, the user, the first sensor, an event, a condition, or any combination thereof.

27. The method of claim 26, wherein the prediction is based on a first location of the first communication device at a first point in time and information in a calendar of the user indicating a second location of the user at a second point in time that is subsequent to the first point in time.
